(19) United States
(12) Patent Application Publication
(10) Pub. No.: US 2021/0031109 A1
(43) Pub. Date: Feb. 4, 2021

(54) AUGMENTED REALITY GAMING SYSTEM

(71) Applicants: David KONYNDYK, Paradise, CA (US); Andrew GARRARD, Paradise, CA (US)

(72) Inventors: David KONYNDYK, Paradise, CA (US); Andrew GARRARD, Paradise, CA (US)

(21) Appl. No.: 16/937,411

(22) Filed: Jul. 23, 2020

Related U.S. Application Data
(60) Provisional application No. 62/881,206, filed on Jul. 31, 2019.

(51) Int. Cl. A63F 13/65; A63F 13/235; A63F 13/803; G05D 1/00

(52) U.S. Cl. CPC A63F 13/65; A63F 13/235; A63F 13/803; A63F 2300/8082; G05D 1/0044; A63F 2300/308; A63F 2300/69; G05D 1/0038

(57) ABSTRACT

An augmented reality gaming system is disclosed. Example embodiments include: an augmented reality game system hub including: a video receiver configured to receive a vehicle video feed from a remotely controlled vehicle; a first interface configured to communicate with a data processing system executing a game engine, the first interface configured to receive augmented reality information from the game engine; and a video multiplexer to generate a combined video feed by combining at least a portion of the vehicle video feed with at least a portion of the augmented reality information; the data processing system executing the game engine; and a player unit configured to control the remotely controlled vehicle.

### PRIORITY PATENT APPLICATION

This non-provisional patent application draws priority from U.S. provisional patent application Ser. No. 62/881,206; filed Jul. 31, 2019. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2018-2020, David KONYNDYK and Andrew GARRARD; All Rights Reserved.

### TECHNICAL FIELD

The present invention pertains to video gaming systems including an augmented reality gaming system.

### BACKGROUND

Video game developers have created a wide variety of types of game systems for virtual world gaming, including combat themes, racing themes, social themes, and other ways for players to interact with the game system and optionally with other players, either locally or remotely. In parallel, hardware developers have created real-world game and sporting systems such as remote-controlled racing cars, drones, and other vehicles. However, conventional systems have failed to combine these two concepts into an integrated gaming system.

### SUMMARY

Example embodiments of the present invention combine virtual world gaming with real-world game and sporting systems, thereby creating an augmented reality gaming system in which sensors on a remote-controlled vehicle, such as a land vehicle, an aquatic vehicle, or an aerial vehicle, are inputs, along with any direct user input, to a game system hub that creates a modified game feed including both real-world content, such as video, and computer-generated content. This game feed may be displayed to gamers or to spectators, recorded for later use, or both.

### BRIEF DESCRIPTION OF THE DRAWINGS

Embodiments are illustrated by way of example and not limitation in the figures of the accompanying drawings, in which:

FIG. 1 shows a schematic view of one embodiment of the invention;

FIG. 2 shows a possible display image for the embodiment shown in FIG. 1;

FIG. 3 shows a schematic view of a remote-controlled vehicle;

FIG. 4 is a more detailed schematic of a different game system hub;

FIGS. 5 through 8 illustrate a detailed schematic view of the embodiment shown in FIG. 1; and

FIG. 9 illustrates a processing flow diagram that shows an example embodiment of a method as described herein.

### DETAILED DESCRIPTION

In the following detailed description, reference is made to the accompanying drawings, which form a part hereof. In the drawings, similar symbols typically identify similar components, unless context dictates otherwise. Drawings are not to scale unless otherwise noted. The illustrative embodiments described in the detailed description and drawings are not meant to be limiting. Other embodiments may be utilized, and other changes may be made, without departing from the spirit or scope of the subject matter presented here.

Multirotor drone racing is currently a popular niche activity, with as many as 20,000 people worldwide building drones and coming together to race them. At such events, drones typically use an FPV (first person view) camera and are controlled with an FPV headset and personal controller. Many other drone enthusiasts prefer not to race, but to build and fly multirotor drones in a freestyle manner, capturing visually exciting video in high-definition and sharing it on social media. Between the hobbies of drone racing and freestyle drone flying, there may be as many as 500,000 multirotor FPV fliers worldwide, with still more FPV users piloting more traditional fixed-wing aircraft.

While racing events are popular with enthusiasts, generating spectator interest has been challenging. The small size and high speeds of the drones (current drones have top speeds of around 120 MPH, but racers continue to push speed records ever higher) have made it difficult for spectators to reliably see the drones at a distance, let alone enjoy the drama of a hard-fought race. Freestyle piloting has seen fair public interest due to high-definition videos shared on the internet, but the artistic stylings of technical pilots are still a niche field of interest.

Example embodiments of the system disclosed herein have an enhanced video feed that allows for games beyond simple racing or freestyle piloting, such as dogfighting, team combat, agility courses, target shooting, or air assaults on ground or aquatic targets, some of which are expected to become popular spectator events both online and at live events. By bringing together the fields of FPV piloting and video gaming, a new crossover field of interest may be created.

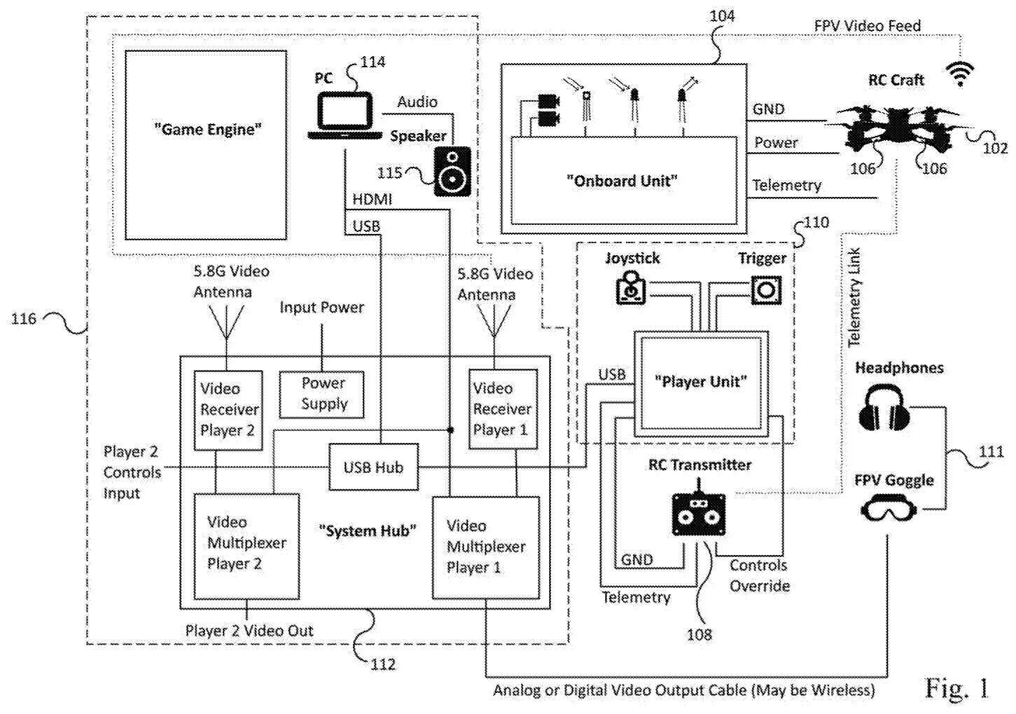

FIG. 1 shows the components of one example embodiment of the invention.

In this embodiment, one or more aerial drones 102 may be equipped with onboard unit 104, which may include a microprocessor, sensors, and optionally one or more beacons, targets, or other detectable components 106. In the illustrated embodiment, drone 102 may be a racing drone such as an ARMATTAN CHAMELEON™, a DIATONE GT-M540™, an EMAX HAWK 5™, or a custom-built freestyle or racing drone. Onboard unit 104 may include, for example, sonic sensors, laser-based optical sensing equipment, or an infrared and/or a visible wavelength photodiode such as an ambient light sensor. Drone 102 may be in wireless communication via radio 108 with player unit 110. In the illustrated embodiment, player unit 110 includes input controllers such as a joystick and trigger, as well as a microprocessor and USB port. Also shown are game display or other rendering components 111, such as headphones and/or a set of FPV goggles. Game system hub 112 may be a standalone component or may further communicate with a computer or data processing system 114 executing a game engine to form virtual data assembly 116. Radio 108 and player unit 110 may provide state data about drone 102, such as attitude, speed, and/or visual environment, to virtual data assembly 116, wirelessly or over a wire, which may then provide audio/visual data to game display components 111. In the illustrated embodiment, computer or data processing system 114 may be a laptop computer suitable for bringing into a drone racing/flying environment, and further includes a speaker 115 for global game audio, which may be audible to both gamers and spectators. Game system hub 112 may collect sensor information from drone 102, radio 108, and player unit 110 via player unit's wired or wireless connection and may combine it with virtual data generated by part or all of assembly 116. For example, a video feed from drone 102 may be combined with computer-generated visible shots (based on data from player unit 110) to create a virtual combat video that shows drone 102 appearing to shoot down aerial or ground-based targets. Signals sent from drone 102 to game system hub 112 may sometimes require very low latency (for example, less than about 20 milliseconds), especially when these include the FPV video feed for a fast flying vehicle.

In some embodiments, this virtual combat video may be passed to game display components 111 to display the combat to a gamer in control of the drone. In some such embodiments, the video sent to display 111 may be of a relatively low resolution in order to maintain speed or responsiveness of the system, while a higher-resolution feed may be generated and locally stored or displayed, either in real time, in near-real time with a processing lag, or with a long processing delay for future high-resolution display. Any of these could include split-screen options. In some embodiments, game system hub 112 may be responsible for combining augmented reality information or video with first-person video and sending the resulting combined feed to display 111, while in other embodiments, game system hub 112 may send augmented reality information and/or real-world display information (such as first-person video) to display 111 for combination at the display 111. Other data besides virtual combat video may also be passed to the display 111, such as directions for haptic feedback to a user, sound signals, status information such as weapon readiness, or to player unit 110, such as directions to modify behavior of controls. For example, if a drone 102 takes a virtual “hit,” it may be directed to become temporarily or permanently less responsive to inputs or throttled (governed) in speed, or it could be biased to one side or even “downed” by the hit. In some embodiments, it may be possible and desirable to direct a craft to simulate a shock wave by overriding control for a fraction of a second, then returning control to the gamer. A video feed sent to display 111 might also be manipulated to include smoke, fire, or other damage, modify the apparent directions (trajectories) of shots, or otherwise respond to game events.

In some embodiments, some or all of the functions of the computer and game system hub assembly 116 may be performed by a local computer, a remote computer, or a smaller unit such as a mobile phone. Those of ordinary skill in the art will understand how to choose appropriate components for these roles in light of system-specific information such as the speed of drone 102, the bandwidth of the connection between drone 102 and radio 108, the amount of sensor 104 information to be processed, and the details of the computer-generated information that will be presented and/or stored by assembly 116.

In some embodiments, drone 102 may include detectable components 106 such as an identifier beacon, for example, an IR LED that blinks a coded sequence, controlled by onboard unit 104. These components may be used for head-to-head combat situations or team combats where friends must be distinguished from foes, but they may also be used in other gaming situations where it is desirable to identify a drone 102. For example, in a classic race, a video feed may include identifiers that show the call signs of other competitors when they appear on the gamer's video. Other possible components of this type include a fixed-size fiducial system that allows game system hub 112 to determine an exact distance and attitude for a competitor drone. In some embodiments, distance may instead be determined by parallax from multiple sensors (typically part of onboard unit 104) on drone 102. This type of component may also be affixed to environmental features that drones 102 may need to recognize, such as no-fly areas (e.g., spectator seating, system hardware areas). In some embodiments, computer vision techniques (e.g., HSV color tracking, meanshift/camshaft tracking, or histogram back-projection tracking) might be used to identify real-world targets, or to enhance them in gamer displays. Some systems may also use more processor-intensive tracking and object recognition techniques, including YOLO or other TensorFlow methods.

In outdoor environments (or indoor environments that include obstacles, no-fly zones, or the like), the game engine and/or some or all drones 102 may have access to a mutual three dimensional (3D) model of the playing space that coincides with the real-world environment. Computer-generated virtual content within the virtual space is spatially and orientationally integrated with real-world FPV video as seen through the drones' onboard FPV cameras. Such a virtual space may be built using GOOGLE EARTH™ or other commercially available models of a physical space, or the space may be manually or automatically mapped to construct the virtual space.

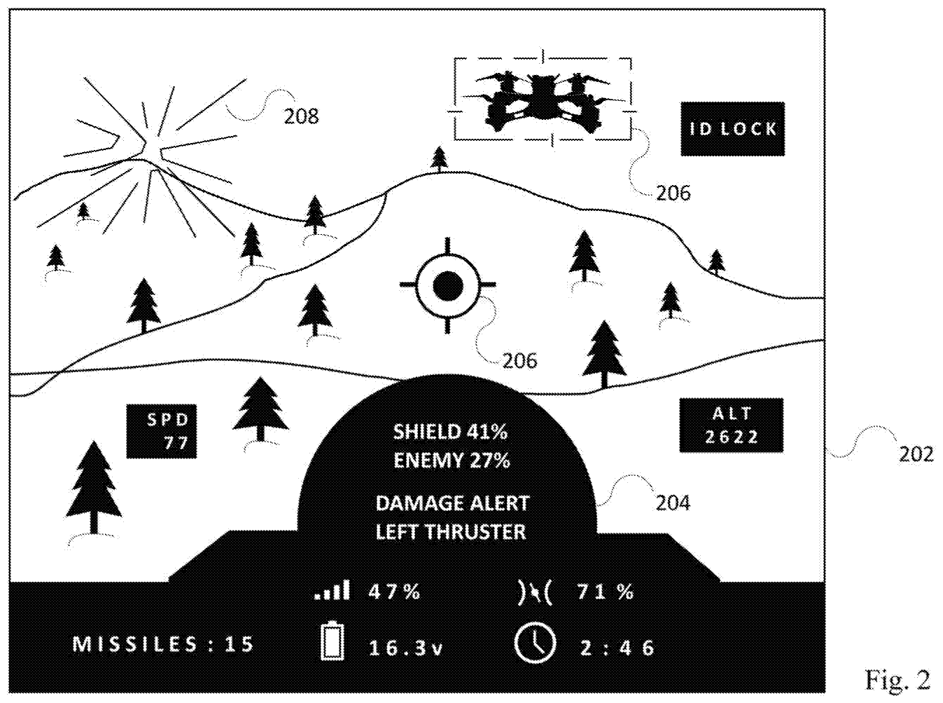

FIG. 2 shows a frame 202 from a possible video display using the system depicted in FIG. 1. Frame 202 shows background video content providing a first-person view of the drone environment. Superimposed on the background video is a cockpit graphic 204 that includes a weapon choice, shield levels, and a damage notification. Also superimposed on the background video are one or more heads-up display combat notifications 206, such as a targeting cross-hair and a craft attitude reticle, and a damage notification 208 (in the illustrated embodiment, showing a cracked windscreen). These display elements update in real-time during flight, allowing the gamer to concentrate on a single display while piloting the drone and controlling weapon systems.

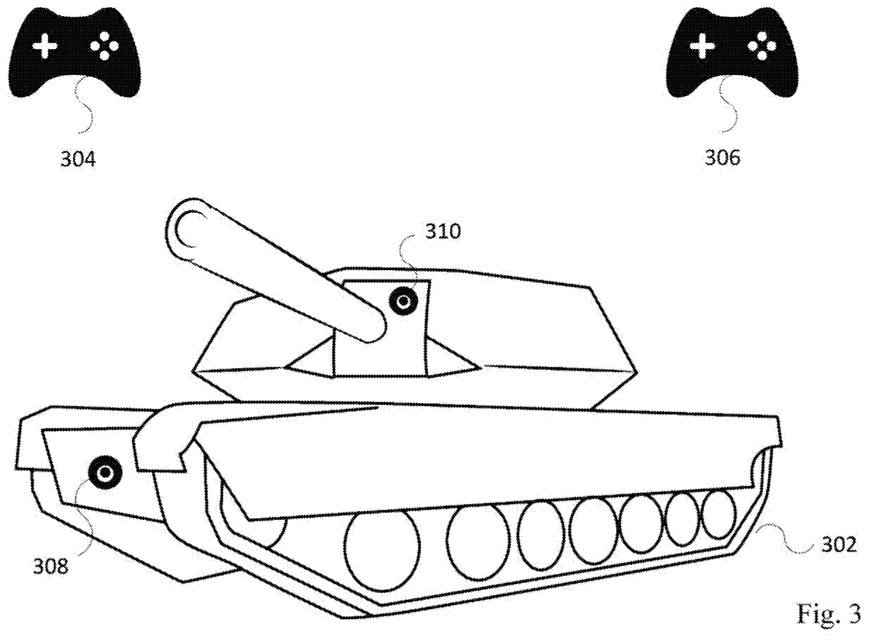

FIG. 3 depicts a land-based remote-controlled vehicle for use with a different embodiment of the invention. The depicted vehicle 302 has two associated controllers 304 and 306, for a driver and a gunner, respectively. In the illustrated embodiment, each user has his own FPV camera, but in other embodiments, users may share a camera or may have access to multiple cameras. The driver camera 308 is mounted on the front of the vehicle and shows the driver what is forward of the vehicle. The gunner camera 310 is affixed to a rotatable gun mount and shows the gamer the area in which the gun is aimed. In other embodiments (not shown), cameras may be movable independent of the vehicle and gun controls. These vehicles are designed for use in a combat game, where different vehicles move about an area and engage in combat. Note that it would also be possible to combine this system with the drone illustrated in FIG. 1, including ground-to-air combat. In a system of increasing complexity, aquatic and/or amphibious vehicles could also be included. Any FPV remotely controlled vehicle (for example, fixed-wing aircraft, single-rotor craft, micro-sized drone, RC car, truck, boat, or hovercraft), can be used for the systems described herein, for example by equipping it with onboard unit 104 described above. Any such systems may optionally include the feedback described in connection with FIG. 1, such as digitally created smoke or haptic feedback. While the simulation of land, water, and air-based combats are known in the video game arena, the combination of real-world vehicles with virtual combat information allows for an exciting hybrid game while minimizing possible damage to vehicles, operators, or observers.

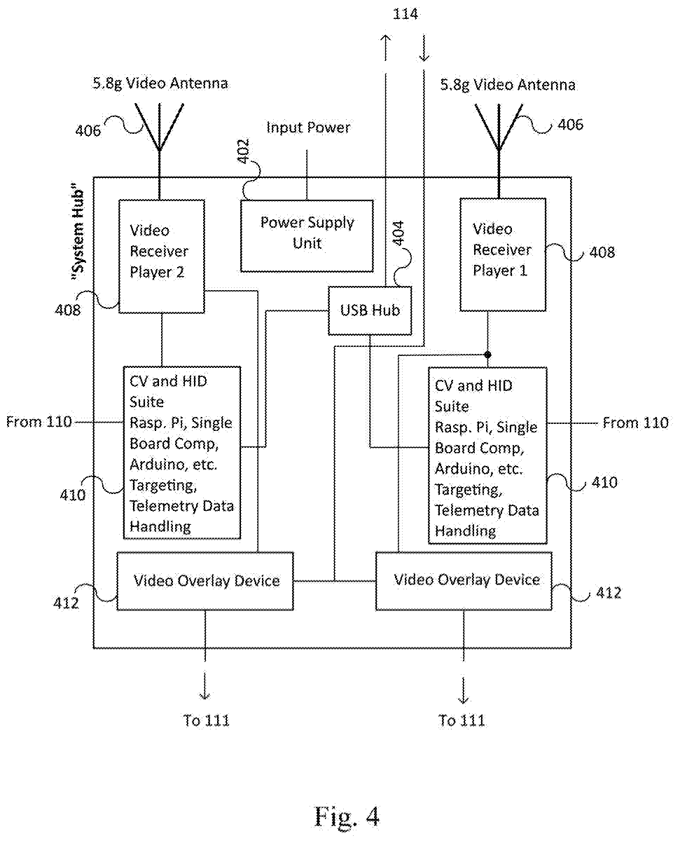

FIG. 4 is a more detailed view of an embodiment of game system hub 112 including a machine vision system. It may include a power supply 402 having an AC or DC power input and a USB hub 404 that are shared by all players. The illustrated embodiment may also include components for each player, including a video antenna 406, a video receiver 408, a computer vision/human interface device (CV/HID) suite 410, and a video overlay device 412. Video antenna 406 and video receiver 408 may acquire a video signal from the camera onboard drone information to be passed to USB hub 404 and/or game engine 114). For 102 via the drone's video transmitter. This video signal may be fed into the CV/HID suite 410. In the illustrated embodiment, player unit 110 may also feed the CV/HID suite 410 a signal containing craft telemetry data from the radio 108, and button press signals and/or control signals received from player unit 110. The CV/HID suite 410 may use computer vision techniques to extract example, CV/HID suite 410 might detect a beacon 106, it might “see” another drone 102 (for example, recognizing a drone silhouette or another identifier such as high-visibility tape or a retroreflector, which may include an identifying shape, color, or other visible characteristic), or it might identify obstacles visible on the video. These data may be sent as signals (e.g., as serial data) to game engine 114 (possibly via USB hub 404) along with HID button press outputs and, in some embodiments, telemetry data from the craft. The game engine 114 may use any or all of this data to create computer-generated game content, which may be sent to the video overlay device 412 for combination with local video signals and to player display device(s) 111. In the illustrated embodiment, the CV/HID suite 410 includes a Raspberry Pi (and an optional Arduino) for computer vision processing, but it will be understood that other components may perform the same function. As discussed above, in other embodiments (not illustrated), a video overlay over the drone camera video may be performed at the display device(s) 111.

In some embodiments, a game system hub 112 or game engine 114 may provide other functionality to players. For example, there may be an online “lobby” where potential participants (whether or not previously known to one another) can rendezvous to begin races or other games. Users may have profiles stored at this level that include information such as hardware configurations, gaming records, and gaming preferences. These profiles may be searchable or otherwise configured to facilitate organization and execution of games.

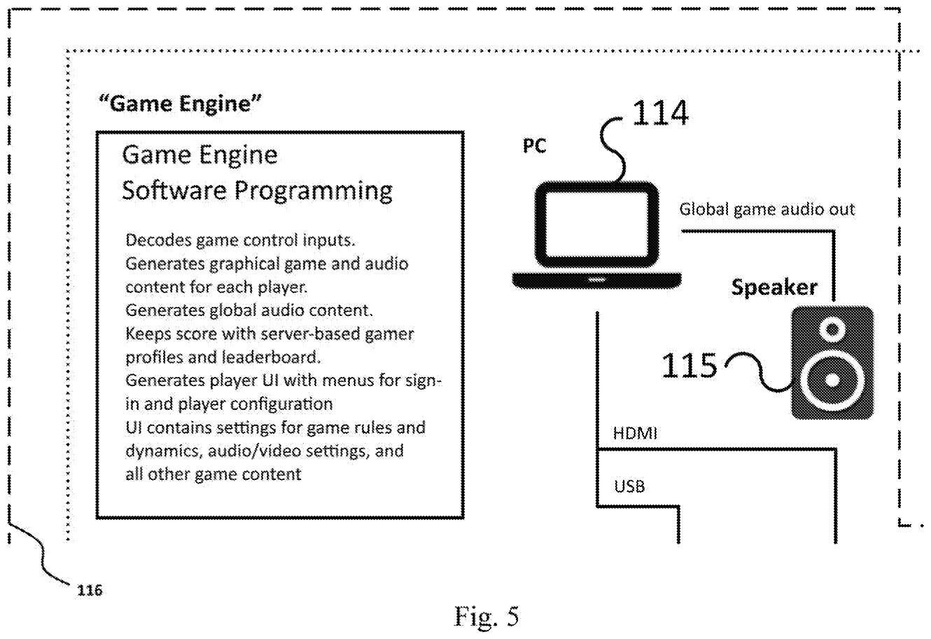

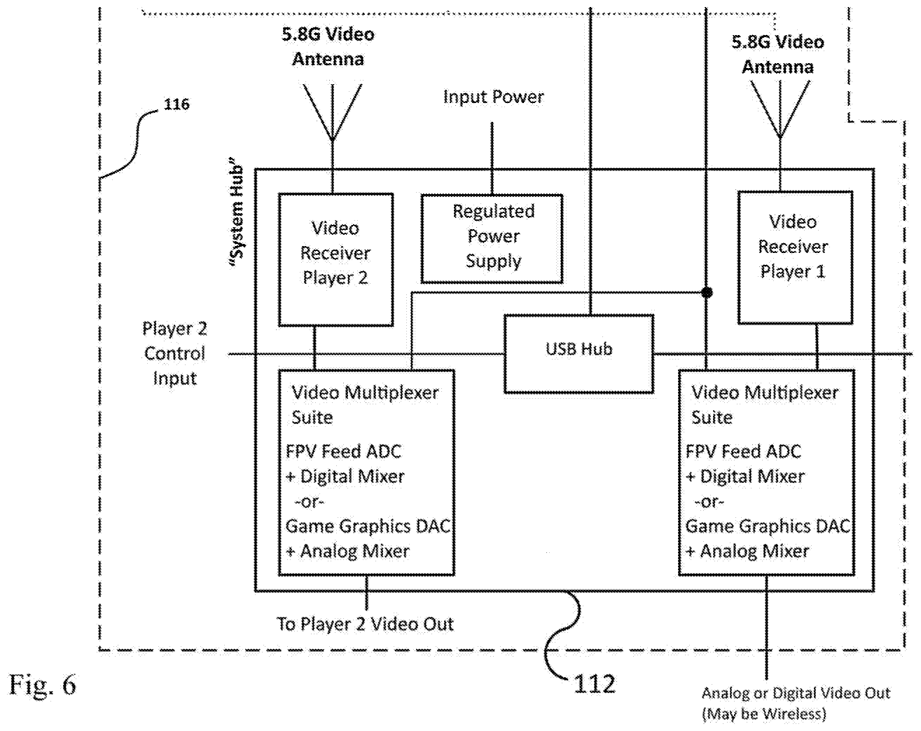

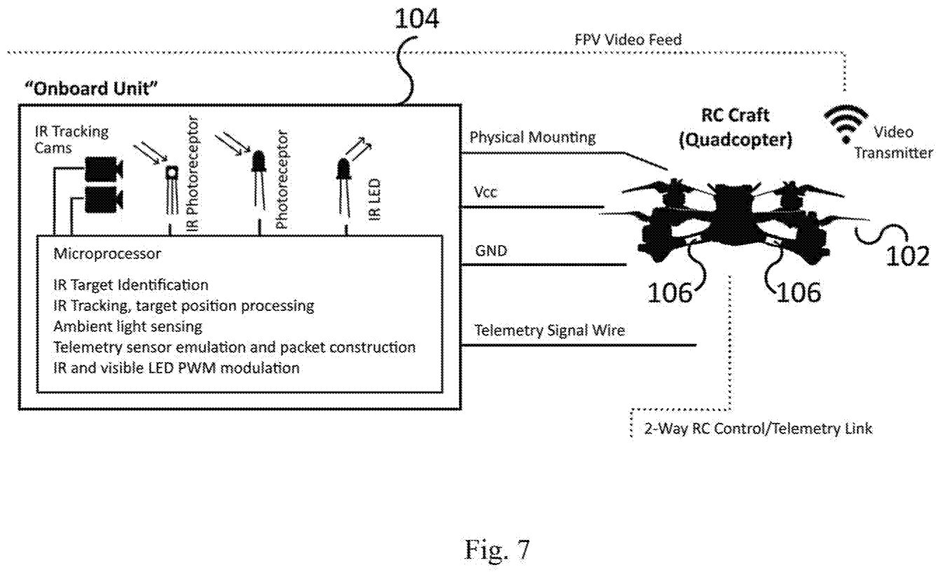

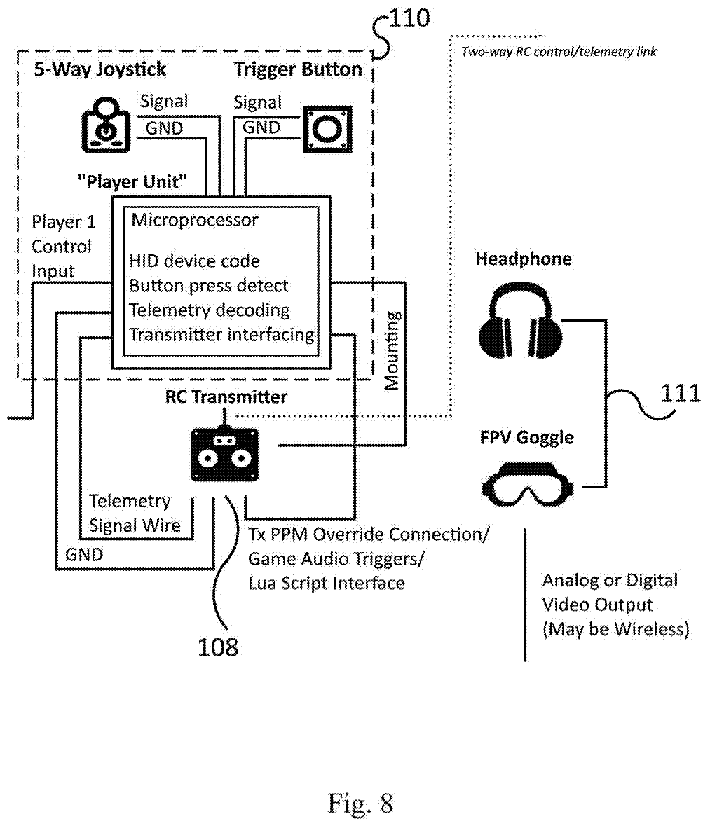

FIGS. 5 through 8 illustrate a detailed schematic view of the embodiment shown in FIG. 1 and described above.

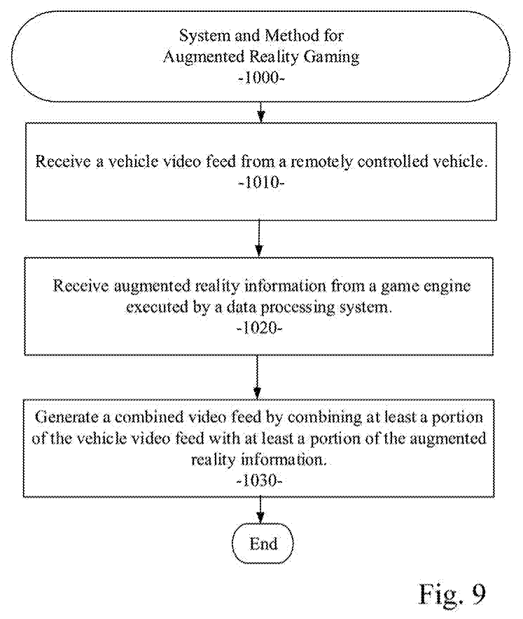

Referring now to FIG. 9, a processing flow diagram illustrates an example embodiment of a method 1000 implemented by the combinations of components for augmented reality gaming as described herein. The method 1000 of an example embodiment includes: receiving a vehicle video feed from a remotely controlled vehicle (processing block 1010); receiving augmented reality information from a game engine executed by a data processing system (processing block 1020); and generating a combined video feed by combining at least a portion of the vehicle video feed with at least a portion of the augmented reality information (processing block 1030).

Various embodiments of augmented reality systems have been described herein. In general, features that have been described in connection with one particular embodiment may be used in other embodiments, unless context dictates otherwise. For example, the two-man vehicle described in connection with FIG. 3 may be employed using the machine vision arrangement depicted in FIG. 4. For the sake of brevity, descriptions of such features have not been repeated, but will be understood to be included in the different aspects and embodiments described herein.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used only for descriptive purposes and not to be construed as limiting. The elements, materials, geometries, dimensions, and sequence of operations may all be varied for particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. An augmented reality game system hub comprising:
a video receiver configured to receive a vehicle video feed from a remotely controlled vehicle;
a first interface configured to communicate with a data processing system executing a game engine, the first interface configured to receive augmented reality information from the game engine; and
a video multiplexer to generate a combined video feed by combining at least a portion of the vehicle video feed with at least a portion of the augmented reality information.

2. The augmented reality game system hub of claim 1 further including a video output interface to provide the combined video feed to a rendering component.

3. The augmented reality game system hub of claim 2 wherein the rendering component is a display device or an audio device.

4. The augmented reality game system hub of claim 1 further including a second data interface configured to receive sensor data from the remotely controlled vehicle, information indicative of the sensor data being included in the combined video feed.

5. The augmented reality game system hub of claim 1 wherein the video receiver, configured to receive the vehicle video feed from the remotely controlled vehicle, is a wireless receiver.

6. The augmented reality game system hub of claim 1 further including a video overlay device to overlay the at least a portion of the vehicle video feed with the at least a portion of the augmented reality information.

7. The augmented reality game system hub of claim 1 wherein the augmented reality information is spatially and orientationally integrated with the vehicle video feed within a virtual space.

8. The augmented reality game system hub of claim 1 wherein the virtual space is mapped to correspond to a physical space.

9. The augmented reality game system hub of claim 1 wherein the remotely controlled vehicle is of a type from the group consisting of: a fixed-wing aircraft, a single-rotor craft, a micro-sized drone, a remotely controlled (RC) car, an RC truck, an RC boat, and an RC hovercraft.

10. A system comprising:
an augmented reality game system hub including:
a video receiver configured to receive a vehicle video feed from a remotely controlled vehicle;
a first interface configured to communicate with a data processing system executing a game engine, the first interface configured to receive augmented reality information from the game engine; and
a video multiplexer to generate a combined video feed by combining at least a portion of the vehicle video feed with at least a portion of the augmented reality information;
the data processing system executing the game engine; and
a player unit configured to control the remotely controlled vehicle.

11. The system of claim 10 wherein the augmented reality game system hub further including a video output interface to provide the combined video feed to a rendering component.

12. The system of claim 11 wherein the rendering component is a display device or an audio device.

13. The system of claim 10 wherein the augmented reality game system hub further including a second data interface configured to receive sensor data from the remotely controlled vehicle, information indicative of the sensor data being included in the combined video feed.

14. The system of claim 10 wherein the video receiver of the augmented reality game system hub is a wireless receiver.

15. The system of claim 10 wherein the augmented reality game system hub further including a video overlay device to overlay the at least a portion of the vehicle video feed with the at least a portion of the augmented reality information.

16. The system of claim 10 wherein the augmented reality information is spatially and orientationally integrated with the vehicle video feed within a virtual space.

17. The system of claim 10 wherein the virtual space is mapped to correspond to a physical space.

18. The system of claim 10 wherein the remotely controlled vehicle is of a type from the group consisting of: a fixed-wing aircraft, a single-rotor craft, a micro-sized drone, a remotely controlled (RC) car, an RC truck, an RC boat, and an RC hovercraft.

19. A method comprising:
receiving a vehicle video feed from a remotely controlled vehicle;
receiving augmented reality information from a game engine executed by a data processing system; and
generating a combined video feed by combining at least a portion of the vehicle video feed with at least a portion of the augmented reality information.

20. The method of claim 19 wherein the remotely controlled vehicle is of a type from the group consisting of: a fixed-wing aircraft, a single-rotor craft, a micro-sized drone, a remotely controlled (RC) car, an RC truck, an RC boat, and an RC hovercraft.
